(19) United States
(12) Patent Application Publication
(10) Pub. No.: US 2006/0202556 A1
(43) Pub. Date: Sep. 14, 2006

(54) Control device for automatic machine

(76) Inventors: Michiharu Tanaka, Fukuoka (JP); Keijro Yuasa, Fukuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/533,569

(22) PCT Filed: Nov. 7, 2003
(86) PCT No.: PCT/JP03/14234

§ 371 Date: Mar. 6, 2006

(30) Foreign Application Priority Data
Nov. 12, 2002 (JP) 2002-327697

(51) Int. Cl. H02J 1/00

(52) U.S. Cl. 307/11; 318/568.11; 700/245; 363/84; 307/116

(57) ABSTRACT

A control apparatus of an automatic machine is provided, while the control apparatus supplies electric power of a power supply in high reliability with respect to a driving apparatus of the automatic machine, and further, has no problem as to ensuring of safety.

In a control apparatus of an automatic machine having a breaker (22) connected to a power supply (21), and a driving apparatus (32) for supplying electric power of the power supply (21) to a driving unit (35) of the automatic machine via a relay apparatus (31) connected to the breaker (21), which controls the driving apparatus (32), the control apparatus is comprised of: a current control rectifying element (33) connected to the relay apparatus (31); and a current controlling device (29) for feed-controlling the current control rectifying element (33) after a contact of the relay apparatus (31) has been closed when supplying of the electric power to the driving unit (35) is turned ON.

### TECHNICAL FIELD

The present invention is related to power supply turning-ON/turning-OFF control operations of a driving apparatus employed in a control apparatus of an automatic machine.

### BACKGROUND ART

In small-scaled parts processing machines using automatic machines such as robots, there are some cases that supplying of workpieces to processing positions is carried out by workers and dismounting of workpieces from processing positions is performed by workers. In these cases, since portions of bodies of the workers are entered into movable ranges of the automatic machines, in such a case that these automatic machines are accidentally actuated, e.g., are brought into runaway operations, safety of these workers may be secured by such a manner that approaches of the automatic machines to these workers are detected by a light curtain, or the like, and then, driving power supplies of the automatic machines are cut off. However, since people recently become aware of safety aspects and cost of the automatic machines is desired to be reduced, safety apparatus are eliminated. Instead of such safety apparatus, during such setup works that the workers are entered into the movable ranges of the automatic machines, the driving power supplies of the automatic machines are cut off in order that safety of the workers may be ensured. Since the driving power supplies are turned ON and turned OFF every time workpieces are supplied, and every time processed workpieces are dismounted, lifetimes of contacts of relay apparatus must be considerably prolonged.

A drive shaft which controls a plurality of shafts used in an automatic machine is arranged by a rectifying circuit, a smoothing capacitor, and a plurality of inverter circuit units. The rectifying circuit converts an AC voltage connected to a relay apparatus such as an electromagnetic contactor into a DC voltage. The smoothing capacitor smoothes the DC voltage after the rectification operation. The plural inverter circuit units convert the DC voltages after the smoothing operations. The inverter units may be controlled based upon PWM instruction signals which are produced by a CPU in accordance with operations of the automatic machine. While the smoothing capacitor is provided in a smoothing circuit, when a power supply is turned ON, a large charge current flows through the smoothing capacitor in this capacitor input type circuit, and thus, there are some risks that contacts of the relay apparatus and rectifying elements of the rectifying circuit unit are damaged.

### PRIOR ART 1

When a power supply is turned ON, since a current from the power supply to a rectifier is bypassed to a resistor, a rush current may be reduced and the reduced rush current is charged to a smoothing capacitor. When the current is decreased, a contact of a relay connected between the both terminals of the resistor is closed, so that the power supply is directly connected to the rectifier. Alternatively, a similar effect may be achieved in such a manner that while a voltage after the smoothing operation is monitored, when the monitored voltage becomes higher than, or equal to a predetermined voltage, the contact of the above-described relay is closed. A description is made with reference to FIG. 6. FIG. 6 is a block diagram for indicating an inverter apparatus 62 for controlling a rotation number of a compressor 66, and a control system thereof. The inverter apparatus 62 is constituted by a rectifying circuit unit 63, a smoothing capacitor 64, and an inverter unit 65. Reference numeral 67 shows an input current sensor for sensing an input current of the inverter apparatus 62, and reference numeral 68 represents an input current converting circuit. The input current converting circuit 68 digitally converts the sensed current, and enters the digitally converted current to a control apparatus (microcomputer) 69. When AC power is supplied from an AC power supply 61 to the inverter apparatus 62, the smoothing capacitor 64 is firstly charged. Reference numeral 71 indicates a resistor element for suppressing a rush current when the charging operation of the smoothing capacitor 6 is commenced. The microcomputer 69 controls a drive circuit 73 when the smoothing capacitor 64 is charged and then the input current value becomes smaller than, or equal to a judging reference value which has been program-set so as to turn ON a relay 72 (refer to Japanese Laid-open Patent Application No. Hei5-168248).

### PRIOR ART 2

As another prior art, one invention has been proposed as to opening operation of contacts of a relay apparatus when a power supply is turned OFF. A problem of the prior art 1 has been described. That is, if the contacts of the relay apparatus are opened under such a condition that a large current flows when the power supply is turned OFF, then an arc may be produced between the contacts. As a result, surfaces of the contacts become rough, and a failure happens to occur. In this prior art 2, in such a case that a driving operation is turned OFF under control of the power supply to the driving apparatus, if a current is larger than, or equal to a predetermined value, then the opening operations of the contacts are not carried out, and after the current has been decreased, the contacts are opened. Referring now to FIG. 7, a detailed explanation is made. The prior art 2 is constituted by a current value detecting means 82 and a control unit 83. The current value detecting means 82 detects a contact current of a relay 81. When a current detected by this current value detecting means 82 exceeds a predetermined reference value, the control unit 83 locks a releasing operation of the relay contacts, and also, when a current value detected by the current value detecting means 82 becomes smaller than, or equal to the reference value, the control unit 83 executes the releasing operation of the relay contacts (refer to Japanese Laid-open patent Application No. Hei11-297176).

### PRIOR ART 3

Also, as another prior art, a method has been proposed by which contacts of a relay are opened/closed near a zero volt of an AC power supply (refer to Japanese Laid-open Patent Application No. 2000-340057).

In the prior art 1, when the power supply is turned ON, since the electric power is supplied via the resistor, the large rush current may be suppressed. However, when the resistance value of the resistor is increased, the charging time for the smoothing capacitor is increased, and thus, the time period during which the motor can be driven by the inverter unit is prolonged. This causes such a time period to be prolonged, which is defined after the driving power supply is turned ON until the operation of the automatic machine can be commenced. As a result, since a time period required for one processing workpiece is prolonged, when productivity is considered, it is so desired that the resistance value of the resistor is decreased, and the time period until the operation of the automatic machine can be commenced is shortened. However, if the resistance value is decreased, then the rush current cannot be sufficiently suppressed, so that the temperature of the resistor conductor instantaneously becomes high due to the own heat generation every time the driving power supply is turned ON, and after the contacts of the relay are closed, the relay is brought into the non-feeding condition. As a result, the resistor conductor is cooled. The resistor conductor is repeatedly expanded and shrunk due to the above-explained heat generation, and thus, there are some possibilities that a wire disconnection failure may occur due to metal fatigue. As a consequence, such a resistor having a large capacity must be selected, namely, a resistor having a large outer dimension must be selected, resulting in a problem, since the control apparatus of the automatic machine is desirably made compact. Also, this large resistor may cause a problem of a cost reduction. Also, since the prior art 1 has no measure when the power supply is cut off, in such a case that while the motor is driven, an emergency stop operation and the like are carried out and the relay apparatus is cut off, the large current is cut off, so that an arc is produced between the contacts of the relay apparatus. As a result, there are certain possibilities that the lifetimes of the contacts are shortened, for instance, the surfaces of the contacts may become rough, so that these contacts may be brought into fusion, or welding.

In the above-described prior art 2, after the current has become lower than, or equal to the predetermined current value, the contacts are opened. As the safety ensuring means in the automatic machine, the driving power supply to the motor is turned OFF by way of the emergency stop operation in the emergency case so as to stop the operation of the automatic machine. As a consequence, in the case that the emergency stop operation is carried out by which the driving power supply is cut off, the contacts of the relay apparatus must be opened irrespective of such a condition that the automatic machine is under operation, or is stopped. In the patent publication 2 in which when the current while the automatic machine is under operation, or the operation of the automatic machine is accelerated becomes larger than a predetermined current value, the contacts of the relay apparatus are not opened, this technical idea cannot be applied to turning-ON and turning-OFF operations of the driving power supply of the robot. Also, in the case that the current detector is arranged in the AC circuit, such an opening control operation as to the contacts of the relay apparatus is carried out which is similar to that of the prior art 3.

The prior art 3 corresponds to such a method for opening/closing the contacts of the relay near the zero volt of the AC power supply. When the contacts are closed, since the charging current flows through the smoothing capacitor as the rush current, the contacts having the capacities capable of allowing this rush current are required. Also, when the contacts of the relay are opened, since the load contains the smoothing capacitor, this load represents the capacitive characteristic. As a result, the current cannot be completely cut off at such a time instant when the contacts are opened, so that an arc may also be produced between the contacts.

In the above-described conventional techniques, with respect to both the rush current flowing when the contacts of the relay apparatus are closed, and the arc produced between the contacts of the relay apparatus when these contacts thereof are opened, such a measure has been taken. That is, the relay apparatus owns the large capacities of these contacts, which maybe suitably fitted to the opening/closing frequencies of the contacts of the relay apparatus. However, in accordance with this measure, the outer dimension of the relay apparatus is increased, which may cause the following problem. That is, if this measure is applied to a control apparatus of an automatic machine which is required to be made compact, then the dimension of this control apparatus becomes bulky. Also, there is another problem that the manufacturing cost of the control apparatus is increased.

### DISCLOSURE OF THE INVENTION

The present invention has been made to solve the above-described problems, and therefore, has an object to provide a control apparatus of an automatic machine, capable of supplying electric power of a power supply in high reliability with respect to a driving apparatus of the automatic machine, and further, having no problem as to ensuring of safety.

To solve the above-explained problems, the present invention is arranged as follows:

According to first invention, there is provided with a control apparatus of an automatic machine including: a breaker connected to a power supply, a driving apparatus for supplying electric power of the power supply to a driving unit of the automatic machine via a relay apparatus connected to the breaker, for controlling the driving apparatus, a current control rectifying element connected to the relay apparatus, and a current controlling device for feed-controlling the current control rectifying element after a contact of the relay apparatus has been closed when supplying of the electric power to the driving unit is turned ON.

According to second invention, there is provided with a control apparatus of an automatic machine including: a breaker connected to a power supply, a driving apparatus for supplying electric power of the power supply to a driving unit of the automatic machine via a relay apparatus connected to the breaker, for controlling the driving apparatus, a current control rectifying element connected to the relay apparatus, and a current controlling device for causing the current control rectifying element to be a non-feeding condition before a contact of the relay apparatus is opened when supplying of the electric power to the driving unit is turned OFF.

As previously described, in accordance with the control apparatus of the present invention, when the driving power supply is turned ON, after the contacts of the relay apparatus have been closed, since a feed control operation for adjusting a feed starting angle of an AC voltage is carried out by the current control rectifying element, the contacts of the relay apparatus are closed under no voltage, and a rush current is suppressed. As a result, a damage given to the contacts of the relay apparatus can be avoided. When the driving power supply is turned OFF, after the feed control operation of the current control rectifying element has been stopped so as to establish a non-feeding operation, since the contacts of the relay apparatus are opened, an arc which is produced when the contacts of the relay apparatus are opened is suppressed and rough conditions as to the contacts of the relay apparatus are be avoided. As a result, there is such an effect that the lifetimes of the contacts of the relay apparatus can be largely prolonged.

### BRIEF DESCRIPTION OF THE DRAWINGS

FIG. 1 is a diagram for representing a structure of a robot system which shows an embodiment mode of the present invention.

FIG. 2 is a block diagram for indicating a driving apparatus and a control unit in the robot system according to the embodiment of the present invention.

FIG. 3 is a flow chart for describing a turning-ON operation of a driving power supply in the robot system according to the embodiment of the present invention.

FIG. 4 is a flow chart for explaining a turning-OFF operation of the driving power supply in the robot system according to the embodiment of the present invention.

FIG. 5 shows a power supply control circuit of the driving apparatus in the robot system according to the embodiment of the present invention.

FIG. 6 is the constructional diagram of the prior art 1.

FIG. 7 is the constructional diagram of the prior art 1.

### BEST MODE FOR CARRYING OUT THE INVENTION

Now, a description is made of a robot control apparatus as a concrete embodiment of the present invention with reference to drawings.

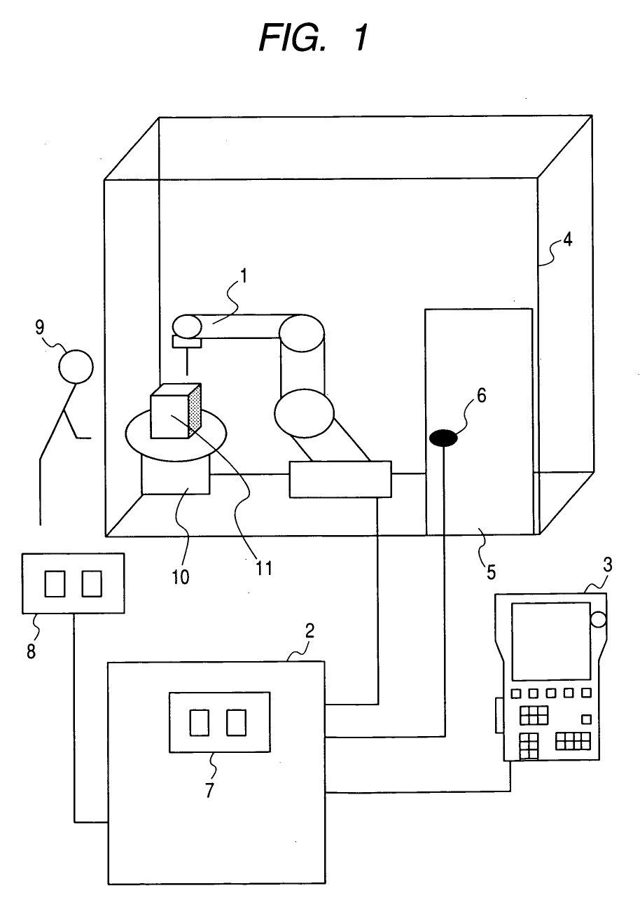

FIG. 1 is a diagram for indicating an arrangement of both a robot control apparatus and a robot system, which represent a first embodiment of the present invention.

In the drawing, reference numeral 1 indicates a robot, and the robot 1 has been connected to a robot control apparatus 2. A work tool used to perform a work has been mounted on a tip of a wrist portion of the robot 1. A pendant 3 has been connected to the robot control apparatus 2. The pendant 3 performs editing operations such as a registration of a work program, or a change in a registered work program by causing the robot 1 to be actuated in a teaching operation so as to execute a position registration, or by registering a work. Also, the robot system has been equipped with a protection fence 4, a protection fence door 5 of a doorway for the protection fence 4, and a door open/close detecting apparatus 6, while this door open/close detecting apparatus 6 has been connected to the robot control apparatus 2. The protection fence 4 surrounds an operation area of the robot 1. The door open/close detecting apparatus 6 detects open/close conditions of the protection fence door 5. While the robot control apparatus 2 has been equipped with an operation panel 7, the operation panel 7 applies a mode changing command, an operation starting command, and a stop command as to an emergency stop switch and the robot system to the robot control apparatus 2. Reference numeral 8 shows an external operation apparatus, and the external operation apparatus 8 has been connected to the robot control apparatus 2. The external operation apparatus 8 applies a mode changing command, an operation starting command, and a stop command as to the emergency stop switch and the robot system to the robot control apparatus 2. A worker 9 mounts a work which should be processed on a workbench 10, or dismounts the work 11 which has been processed by the robot 1 from the workbench 10 through an opening portion (not shown) of the protection fence 4. In this case, since at least a portion of a body of the worker 9 is entered into a movable range of the robot 1, the worker 9 mounts, or dismounts the work 11 after the driving power supply of the robot 1 has been turned OFF, or cut off by way of an emergency stopping operation of the external operation apparatus 8 in order to ensure safety of the worker 9.

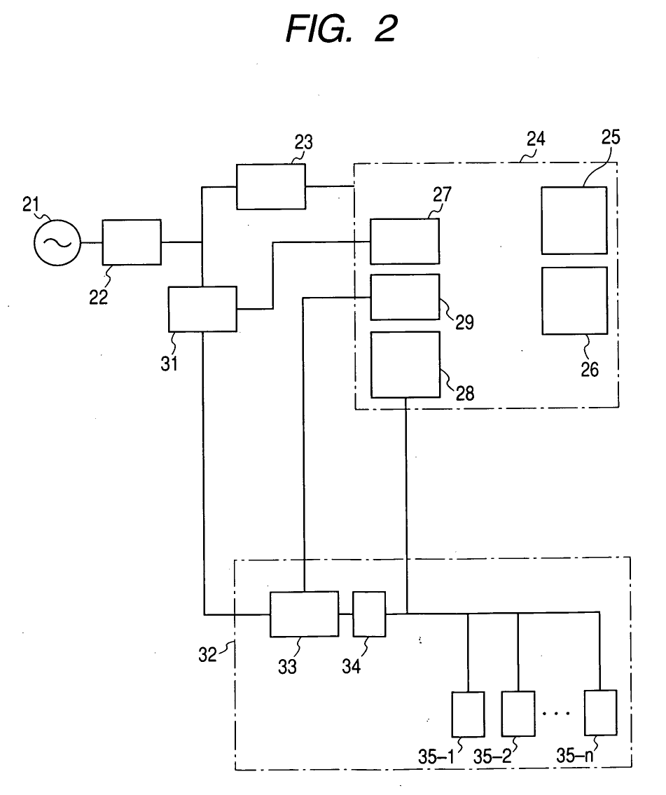

FIG. 2 is a block diagram for indicating a driving apparatus and a control unit thereof so as to embody the present invention. In the drawing, reference numeral 21 shows a power supply used to control and drive the robot. The power supply 21 is conducted to the robot control apparatus 2, and turning-ON and turning-OFF operations of a power supply as to the robot control apparatus 2 are carried out by a breaker 22. Reference numeral 23 represents a control-purpose power supply apparatus. While the control-purpose power supply apparatus 23 has been connected to the load side of the breaker 22, this control-purpose power supply apparatus 23 supplies electric power which is required for a control board 24. Also, the power supply 21 has been connected from the load side of the breaker 22 to the control-purpose power supply apparatus 23, and also has been branched for a driving operation to be connected to a relay apparatus 31, and then, has been conducted from the load side of this relay apparatus 31 to a driving apparatus 32. The control board 24 is arranged by a CPU and memory 25, an input/output interface 26, a relay apparatus interface 27, a current controlling device 29, and a driving voltage interface 28. The CPU and memory 25 controls the robot system in a unification manner. The input/output interface 26 transmits and receives a signal with respect to either the operation panel 7 or the external operation apparatus 8. The relay apparatus interface 27 issues a control signal to the relay apparatus 31 which turns ON and turns OFF supplying of the electric power to the driving apparatus 32. The current controlling device 29 performs a rectification control of an AC voltage of the power supply 21 which is inputted via both the breaker 22 and the relay apparatus 31 to the driving apparatus 32. The driving voltage interface 28 detects a drive-purpose voltage which has been smoothed after the rectification. It should also be noted that such structural elements other than those of the control board 24 are not shown, which are related to the present invention. In the driving apparatus 32, an AC voltage is rectified by a current control rectifying element 33 under control of the current controlling device 29, the rectified voltage is smoothed by a smoothing apparatus 34, and then, the smoothed voltage is connected to driving units 35-1, 35-2, - - - , 35-n, which drive respective shaft driving motors (not shown) of the robot 1. The driving units 35-1, 35-2, - - - , 35-n drive the respective shaft driving motors of the robot 1 under control of the control board 24 (control signals of driving units are not shown).

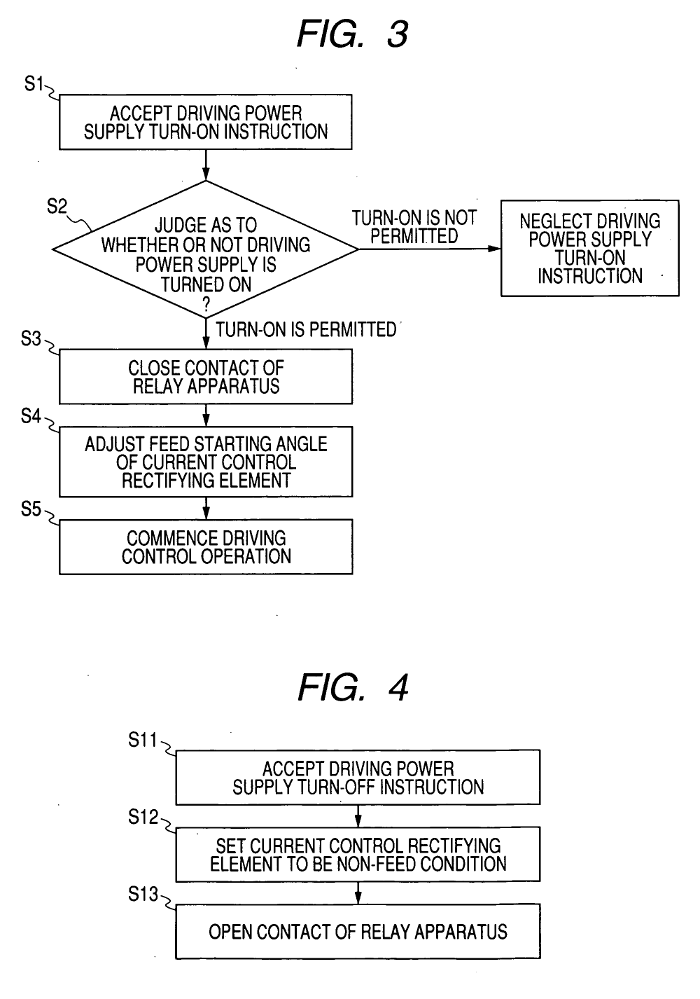

Referring now to a flow chart shown in FIG. 3, a description is made of operations of the respective structural elements when the driving power supply is turned ON in the embodiment of the present invention.

When an instruction for turning ON the driving power supply is inputted to the external operation apparatus 8 by the operator 9 (S1), the CPU confirms as to whether or not the driving power supply can be turned ON based upon a status of the emergency stopping operation, a mode of the robot system, and respective statuses of the protection fence door 5. If the driving power supply can be turned ON, then the process operation of the CPU is advanced to a step in which the driving power supply is turned ON. If the driving power supply cannot be turned ON, then the CPU neglects the turning-ON instruction of the driving power supply, and does not turn ON the driving power supply (S2). Next, a contact of the relay apparatus 31 is closed in order that the entered power supply 21 is connected to the driving apparatus 32. In this case, since the current control rectifying element 33 of the driving apparatus 32 is not feed-controlled by the current controlling device 29, no current may flow through the contact of the relay apparatus 31. As a result, an arc is not produced, but also, a rush current never flows through the contact at a time instant when the contact is closed (S3). Next, the current controlling device 29 commences the feed-control operation of the current control rectifying element 33. Since the current controlling device 29 adjusts a feed starting angle of an AC voltage based upon a voltage across both the terminals of the smoothing apparatus 34 after the rectification, an excessively large rush current does not flow (S4). At this time, in such a case that a voltage across both the terminals of the smoothing apparatus 34, which is acquired by the driving voltage interface 28, is not increased within a preset time, an occurrence of a shortcircuit in wiring lines up to the driving units 35-1, 35-2, - - - , 35-n, or an occurrence of a failure of shortcircuit modes as to the driving units 35-1, 35-2, - - - , 35-n may be detected. Next, after a voltage across both the terminals of the smoothing apparatus 34, which is acquired by the driving voltage interface 28, is reached to a preset voltage, namely such a voltage capable of driving/controlling the respective shaft driving motors by the driving units 35-1, 35-2, - - - , 35-n, the CPU executes driving/controlling operations of the respective shaft driving motors (S5).

Referring now to a flow chart shown in FIG. 4, a description is made of operations of the respective structural elements when the driving power supply is turned OFF in the embodiment of the present invention.

When an instruction for turning OFF the driving power supply such as operation of the emergency stop switch is inputted to the external operation apparatus 8 by the operator 9 (S11), the current controlling device 29 reduces a rectified current of the current control rectifying element 33 and stops the power feeding operation (S12), and then, the contact of the relay apparatus 31 is opened (S13).

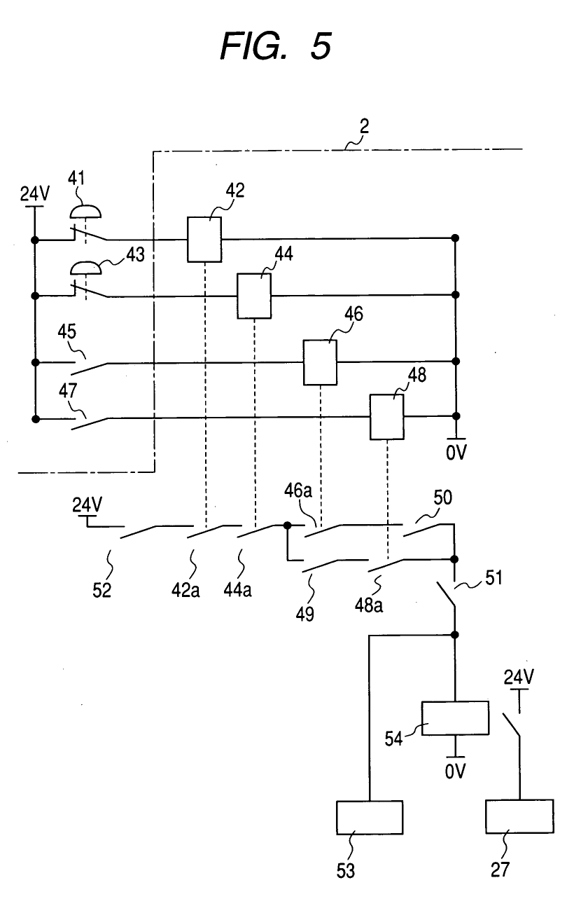

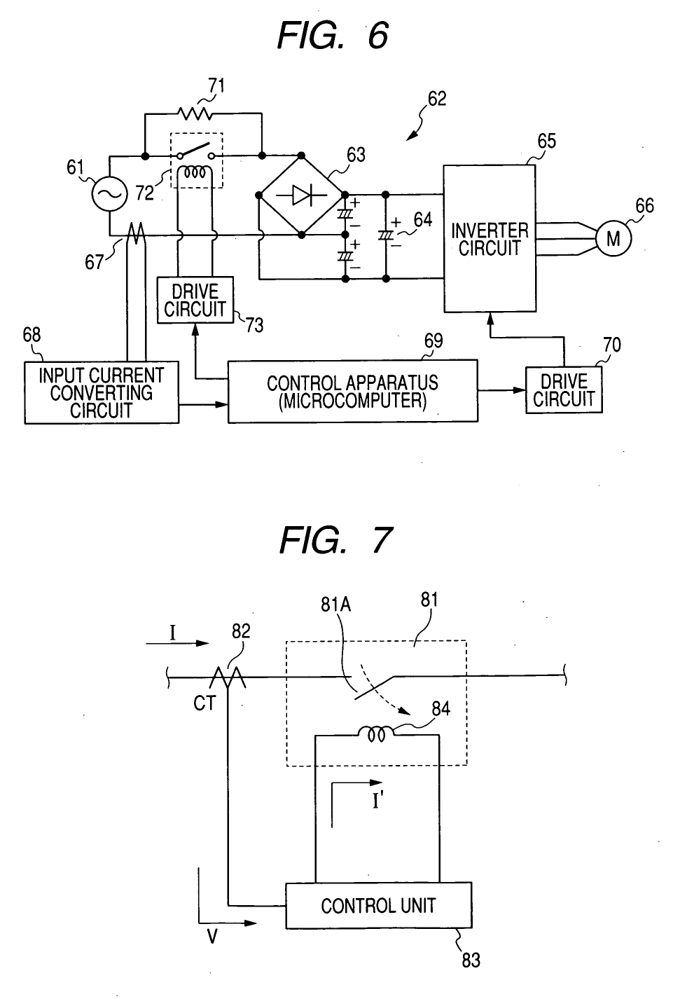

FIG. 5 is a power supply control circuit of the driving apparatus, for indicating both the relay apparatus interface 27 and the input/output interface 26, which control turning ON and OFF operations of the power supply to the driving apparatus 32 so as to embody the present invention. In this drawing, reference numeral 41 shows an emergency stop switch of the external operation apparatus, reference numeral 43 represents a pendant emergency stop switch, reference numeral 45 indicates an enable switch, and reference numeral 47 shows a door open/close detecting apparatus switch. While an operation of the robot 1 is carried out by the pendent 3, the enable switch 45 is employed so as to ensure safety of a worker in the case that the respective driving shaft motors are driven. While these switches 41, 43, 45, 47 have been connected to the input/output interface 26, the respective switches have been connected to an external operation apparatus emergency stop relay 42, a pendant emergency stop relay 44, an enable switch relay 46, and a door open/close relay 48. It should be understood that the enable switch 45 is closed when the respective driving shaft motors are driven, and the contact of the door open/close detecting apparatus switch 47 is closed when the door is closed. While a plurality of relays (not shown) have been provided on the control in addition to these above-described relays, opening/closing operations of these plural relays are controlled based upon a status of the CPU, or controlled by the CPU. Connection conditions of contacts of these relays are defined as follows: That is, a CPU normal status relay contact 52 which is closed when the CPU is operated under normal condition, an external operation apparatus emergency stopping relay contact 42a, and a pendent emergency stopping relay contact 44a have been series-connected to each other from a control power supply of 24 V. A circuit in which an enable switch relay contact 46a is series-connected to a teach mode relay contact 50 which is closed when the teach mode is selected has been connected parallel to another circuit in which an actuation mode relay contact 49 which is closed when an automatic machine selects an actuation mode is series-connected to a door open/close relay contact 48a, while the parallel circuit has been connected to the other terminal of the pendant emergency stop relay contact 44a. While a driving power supply controlling relay contact 51 has been connected to the above-described circuits, the CPU reads a signal status via an input interface circuit 53 from the other terminal of the driving power supply controlling relay contact 51, and the input interface circuit 53 has been connected parallel to a relay apparatus controlling relay 54 corresponding to an OFF-delay relay. A signal of a relay apparatus controlling relay contact 54a controls to open/close the contact of the relay apparatus 31 via a relay apparatus interface 27.

In this circuit, when an emergency stop of the external operation apparatus 8 is operated as the driving power supply turn-ON instruction, the contact of the emergency stop switch 41 of the external operation apparatus is opened, so that the external operation apparatus emergency stopping relay 42 is turned OFF, and thus, the external operation apparatus emergency stopping relay contact 42a are opened. As a result, since the input of the input interface circuit 53 becomes no voltage, the CPU identifies that the driving power supply turn-ON instruction is entered. Then, the CPU reduces the rectified current of the current control rectifying element 33 and stops the power feeding operation via the current controlling device 29. While the CPU reduces the rectified current of the current control rectifying element 33 and stops the power feeding operation via the current controlling device 29, since the relay apparatus controlling relay 54 corresponds to the OFF-delay relay, the relay apparatus controlling relay contact 54a has not yet been opened, and will be opened after a predetermined time (for instance, 0.1 second) has elapsed. This relay apparatus control relay 54 opens the contact of the relay apparatus 31 via the relay apparatus interface 27 so as to interrupt supplying of the electric power to the driving apparatus 32.

### INDUSTRIAL APPLICABILITY

In the automatic machine equipped with the driving shafts, the control apparatus is usefully employed so as to prolong the lifetime of the relay device of the control apparatus which frequently repeats turning-ON and turning-OFF operations of the driving shaft power supply.

1. A control apparatus of an automatic machine comprising:
a breaker connected to a power supply,
a driving apparatus for supplying electric power of the power supply to a driving unit of the automatic machine via a relay apparatus connected to the breaker, for controlling the driving apparatus,
a current control rectifying element connected to the relay apparatus, and
a current controlling device for feed-controlling the current control rectifying element after a contact of the relay apparatus has been closed when supplying of the electric power to the driving unit is turned ON.

2. A control apparatus of an automatic machine comprising:
a breaker connected to a power supply,
a driving apparatus for supplying electric power of the power supply to a driving unit of the automatic machine via a relay apparatus connected to the breaker, for controlling the driving apparatus,
a current control rectifying element connected to the relay apparatus, and
a current controlling device for causing the current control rectifying element to be a non-feeding condition before a contact of the relay apparatus is opened when supplying of the electric power to the driving unit is turned OFF.
